(19) United States
(12) Patent Application Publication
(10) Pub. No.: US 2003/0119646 A1
(43) Pub. Date: Jun. 26, 2003

(54) Centrifugal weir

(76) Inventor: Lynn C. Lundquist, Portland, OR (US)

Correspondence Address: Mr. Lynn Lundquist, 10833 N.E. Russell, Portland, OR, 97220, US

(21) Appl. No.: 10/027,346

(22) Filed: Dec. 20, 2001

(51) Int. Cl. B04B 1/04

(52) U.S. Cl. 494/27; 494/43

(57) ABSTRACT

This invention provides a centrifugal weir that may be placed in series with conventional piping between a source of contaminated liquid and a discharge point within an industrial setting. Further, this weir allows continuous flow from the source of contamination to the discharge point without requiring settling ponds or reservoir systems. The centrifugal forces generated on the liquid inside the rotating weir greatly accelerate settling of heavy solid material from the liquid. The invention further provides a simplified means of cleaning the centrifugal weir. In a second embodiment, the centrifugal weir uses a removable cartridge. The compact unit of the second embodiment may be used in dental offices to separate amalgam from rinse water and for limited wastewater handling in chemistry laboratories.

### BACKGROUND

1. Field of this Invention

This invention provides a centrifugal weir that may be placed in series with conventional piping between a source of contaminated liquid and a discharge point. Further, this weir allows continuous flow from the source of contamination to the discharge point without requiring settling ponds or reservoir systems. In a second embodiment, the centrifugal weir uses a removable cartridge.

2. Description of the Prior Art

Weirs of many designs are used in agriculture and industry. The large majority are open weirs with some form of weir plate adjustment for the purpose of controlling flow. For example, both Smith et al. in WEIR (U.S. Pat. No. 5,674,029) and Plachy et al. in ADJUSTABLE WEIR FOR LIQUID DISTRIBUTION SYSTEMS (U.S. Pat. No. 5,680,989) demonstrate weirs developed for the purpose of fluid control. In another arrangement of a weir, Fassbender et al. in METHOD AND APPARATUS FOR WITHDRAWING EFFLUENT FROM A SOLIDS-CONTACTING VESSEL HAVING AN ADJUSTABLE WEIR (U.S. Pat. No. 5,695,648) incorporate a weir into the design of a vessel for the purpose of separating solid material from liquid. A weir may also serve the purpose of a scrubber as taught by Carson in MULTIPLE WEIR SCRUBBER (U.S. Pat. No. 6,210,468 B1).

Weirs are also frequently incorporated into centrifuge equipment. Hiller in SOLID-SHELL SCREW-CONVEYOR CENTRIFUGE (U.S. Pat. No. 3,955,756) and Miyano et al. in DECANTER CENTRIFUGE HAVING A DISC-LIKE DIP WEIR WITH A HOLE (U.S. Pat. No. 5,306,225) use weirs to separate components within the mix.

This invention is novel in that it uses a static weir without requiring augers or moving overflow weirs. Its function is analogous to an open tank weir with fixed weir members. However, to increase the gravitational force acting on the liquid and solids, the static weir of this invention is accelerated to high angular velocity in order to decrease the time required for heavy material separation from the liquid. The invention provides a simple means of controlling the direction of fluid flow without the use of pumping means. The industrial version of this invention is also novel in its provision for a timesaving means of cleaning the contamination from the internal structure of the cylindrical weir.

An embodiment of this invention intended for use in low volume fluid flow applications is novel in the incorporation of a design with a self-sealing cartridge. In this design, the cartridge not only contains the weir system, but incorporation of an infeed and discharge valve makes the cartridge removable and suitable for safe transport to a facility equipped to handle the contaminated waste.

### OBJECTIVES OF THIS INVENTION

This invention was developed to satisfy, at a minimum, the following objectives:

1. It is the general objective of this invention to develop a centrifugal weir having sufficient settling capacity in its rate of separation to accommodate the full flow of the piping system supplying it.

2. Another objective of this invention is to greatly reduce the physical size requirements from that of an open weir system of equal capacity.

3. Another objective of this invention is to greatly increase the gravitational forces of a weir system.

4. Another objective of this invention is to provide a weir capable of satisfactorily separating suspended materials having a specific gravity similar to that of the liquid in which they are suspended.

5. Another objective of this invention is to provide a simple means of controlling the direction of flow in the weir without the addition of moving parts.

6. Another objective of this invention is to provide a satisfactory method of cleaning an enclosed centrifugal weir.

7. Another objective of this invention is to concentrate the solid waste in the wash-down cycle.

8. Another objective of this invention is to develop cartridge containment of the solid waste.

9. A final objective of this invention is to provide a sealed cartridge that can be removed from the apparatus without inadvertent spilling of contaminated liquid.

These and other objectives and advantages of the present invention, and the manner in which they are achieved, will become apparent in the following specifications and claims.

### SUMMARY OF THIS INVENTION

A typical open weir causes the liquid flow to move along a tortuous path causing the heavy materials to fall to the bottom of the weir and the light materials to remain contained on the surface. Weirs are progressive in nature causing further separation with each successive stage. Thus, increasing the length of a weir generally increases its effectiveness.

The effectiveness of a weir is also highly dependent on the gravitational forces acting on the materials suspended in the liquid. An open stationary weir produces one gravitational unit of force on all suspended solids. Heavy contaminants such as sand in water readily separate under these forces. However, as the specific gravity differential between the liquid and the solid waste material decreases, dwell time in the weir must be increased to achieve satisfactory separation. In this invention, subjecting the weir system to high gravitational forces through centrifugal action greatly enhances the separation rate while at the same time allows a considerable reduction in the physical size for a weir system of a given capacity.

Within industrial applications, there is frequently the need to separate suspended solids having a similar specific gravity to the wastewater bearing it. It is also frequently necessary to treat large volumes of the contaminated water. In many of these applications, open stationary weirs cannot be used because the separation rate is too slow for economical solid waste recovery. However, in this invention, because the separation rate can be controlled by the amount of centrifugal force applied to the contaminated water, a weir system can economically be build to accommodate a large flow rate. This system has the further advantage of greatly reducing the physical size of a weir system for a given treatment capacity.

Any weir system must be physically cleaned when the holding areas become clogged with solid waste. In the large capacity industrial centrifugal weir system of this invention, this is accomplished by tipping the mount of the centrifugal weir so that natural draining occurs and pressure washing the inside surfaces of the weir while slowly rotating the weir body. Because the washing process can be confined in this invention, the washing process is more quickly accomplished than in open weirs. Further, because the washing process waste can be concentrated by use of hydro-cyclones, mechanical screen filters, or even auxiliary centrifugal weirs, the solid waste slurry needs little post washing treatment for final disposal. Of great advantage is the absence of added chemicals or materials in the cleaning process. Thus, secondary processes for disposing or salvage of chemicals or filter materials that were not a part of the original wastewater effluent are significantly decreased.

A second embodiment of the invention is provided for the treatment of small volumes of wastewater. This application occurs in dentist's offices where mercury contaminated amalgam must be removed from mouth rinse water. Similar applications would be found in small chemistry labs and the like. In this embodiment of the invention, a cartridge is used as the centrifugal weir. An infeed and discharge valve is built into the cartridge so that the cartridge becomes a sealed unit whenever the motor drive is stopped or the cartridge is removed for disposal. Thus there is neither handling of open waste nor cleaning of the weir required in the dental office or chemical lab. Because the cartridge of this centrifugal weir is sealed, it can be placed in an inexpensive containment vessel for shipping to a disposal or remanufacturing center. The cartridge unit was designed to accommodate re-use by the customer after cleaning at a centralized facility.

### BRIEF DESCRIPTION OF THE DRAWINGS

FIG. 1 is a sectional view of the centrifugal weir.

FIG. 2 is an elevation view of an underflow weir along line 2-2 of the centrifugal weir in FIG. 1.

FIG. 3 is an elevation view of an overflow baffle along line 3-3 of the centrifugal weir in FIG. 1.

FIG. 4 is an elevation view of the centrifugal weir of FIG. 1 represented as a complete assembly including the discharge boost pump and catch basin.

FIG. 5 is a partial sectional view of a centrifugal weir during cleaning including a partial elevation view of additional components in the washing system.

FIG. 6 is a sectional view of a compact centrifugal weir cartridge and drive housing.

### DESCRIPTION OF THE PREFERRED EMBODIMENTS

In the following descriptions, a prime number indicates a continuous single detail of a similarly numbered item that appears to be broken by the drawing method.

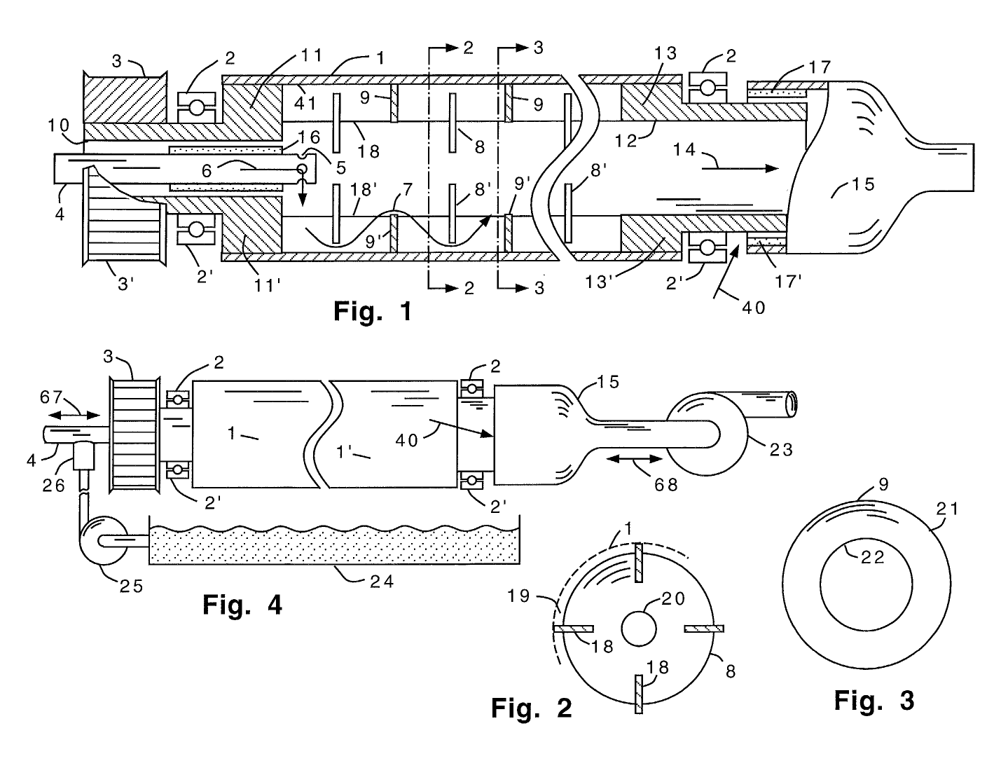

FIG. 1 shows the internal construction of the preferred embodiment of the centrifugal weir for industrial use. The centrifugal weir consists of a rotating weir body 1 provided with bearing elements 2 for mounting. The weir body 1 has an externally mounted sheave 3 used for rotary power transmission to the body. Contaminated liquid is conveyed into the rotating weir through the infeed pipe 4 and discharged through the infeed pipe ports 5 as indicated by arrow 6. The contaminated liquid follows a tortuous path as indicated by arrow 7 wherein the flow must pass under a series of underflow weirs 8 and over an alternating series of overflow baffles 9. Inasmuch as a weir is a gravity fed system, the liquid flow will be toward the lowest point. The inside diameter 10 of the drive hub 11 is smaller, and thus higher relative to the liquid level, than the inside diameter 12 of the discharge hub 13. Thus, liquid flow is toward the discharge hub 13 as indicated by arrow 14. Inasmuch as the weir body 1 is rotating at high speed and the infeed pipe 4 and discharge bell 15 are stationary, anti-galling devices are provided as an infeed pipe bushing 16 and a discharge bell bushing 17.

FIG. 2 shows the full underflow weir 8 detail. Each underflow weir 8 is solidly affixed to a plurality of baffle plates 18. The baffle plate 18 contains the water so that it is somewhat stationary relative to the rotary motion of the weir body 1. The baffle plate 18 is also the means of providing the necessary space 19 between the weir body 1 and the underflow weir 8. A hole 20 is provided in the underflow weir 8 for passage of a pressure-washing wand.

FIG. 3 shows the detail of an overflow baffle 9. The outer diameter 21 of the overflow baffle is substantially the inside diameter of the weir body 1. The diameter of the overflow baffle hole 22 is substantially that of the inside diameter 12 of the discharge hub 13.

FIG. 4 shows an operational assembly consisting of the weir body 1 and related assemblies. A discharge bell 15 is attached to a boost pump 23 that draws the liquid flow from the rotating weir body 1. A catch basin 24 is generally provided to catch leakage. A return pump 25 directs the leakage liquid back into the infeed pipe 4 by way of a directional flow valve 26. Prior to tipping the weir body assembly for cleaning, the infeed pipe 4 is retracted as indicated by arrow 67 and the discharge bell 15 is retracted as indicated by arrow 68.

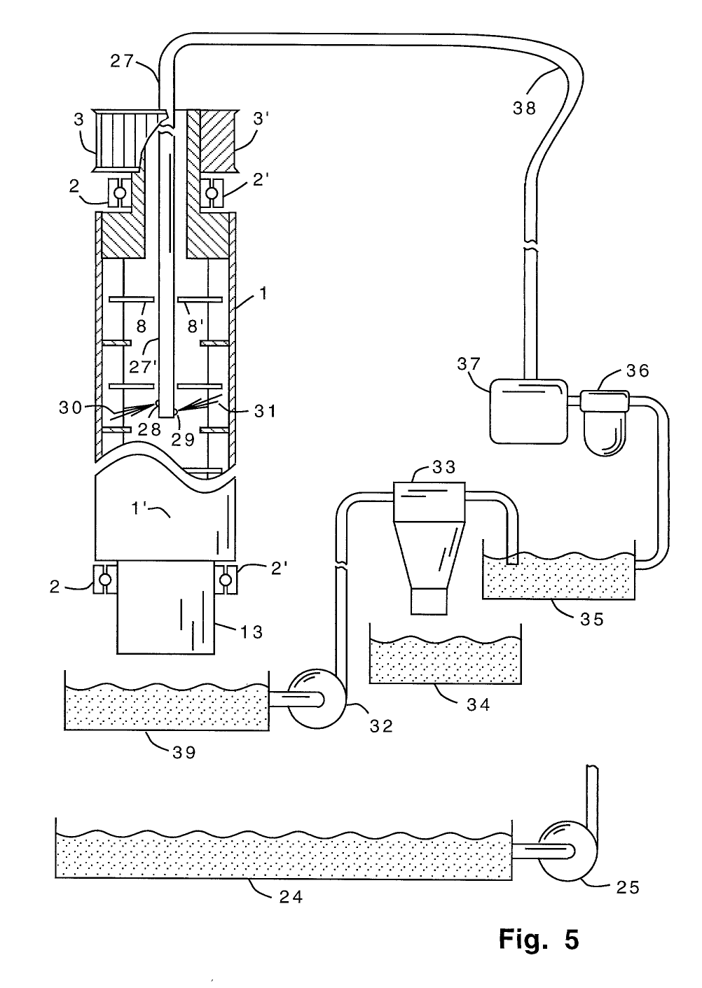

FIG. 5 shows a centrifugal weir in its cleaning position. The weir body 1 is tipped to a vertical orientation wherein a pressure-washing wand 27 is lowered into the assembly. The pressure-washing wand 27 is provided with a plurality of spray nozzles 28 and 29 which direct a high pressure spray 30 and 31 against the inside of the weir body 1. Contaminated wash liquid drains from the discharge hub 13 into a wash-down catch basin 39 from which it is conveyed by the wash-down catch basin pump 32 to a hydro-cyclone 33. Separation in the hydro-cyclone 33 results in heavy solids falling into the solids catch basin 34 and the clear-water settling tank 35. Liquid is then drawn from the clear-water settling tank 35 through a filter 36 by the pressure wash pump 37 and conveyed to the pressure-washing wand 27 through appropriate flexible lines 38.

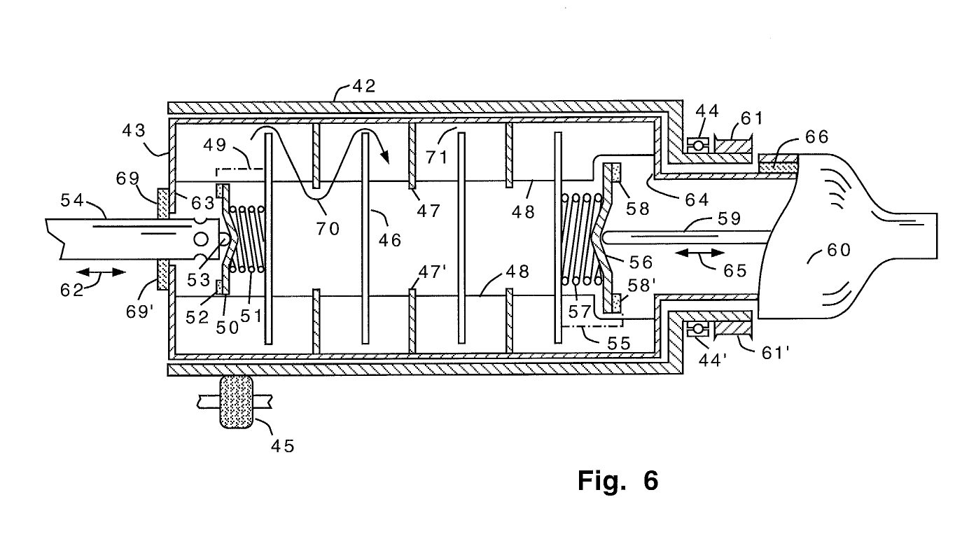

FIG. 6 shows a compact unit using a centrifugal weir cartridge. In this embodiment, the drive housing 4 2 provides structural confinement for the relatively thin shell of the weir cartridge 43. The drive housing 42 is supported on the drive input end by anti-friction bearings 44 and on the open end by a plurality of idler wheels 45. The weir cartridge 43 has a series of underflow weirs 46, overflow baffles 47, and baffle plates 48 which are configured much like the centrifugal weir of FIG. 1. The weir cartridge has an infeed valve 49 consisting of an infeed valve plate 50, an infeed valve spring 51 and an infeed valve seal 52. The infeed valve 49 is opened by the infeed pipe thrust bearing 53 that is affixed to the extremity of the infeed pipe 54. The weir cartridge also has a discharge valve 55 consisting of a discharge valve plate 56, a discharge valve spring 57 and a discharge valve seal 58. The discharge valve 55 is opened by the discharge valve push rod 59 that is movably attached to the discharge bell 60.

Operation

FIG. 1 represents a preferred industrial embodiment of this invention. Rotational force is provided on the weir body 1 by means of a belt connection between the externally mounted sheave 3 and a belt-connected prime mover. After the weir body 1 is brought to operating rotational velocity, liquid is released to flow through the infeed pipe 4 and will consequently flow through the infeed pipe ports 5. Liquid will flow through the weir assembly as indicated by the tortuous path 7. The liquid level is determined by the elevation of both the overflow baffle hole 22 and the inside diameter 12 of the discharge hub 13. In practice, both the overflow baffle hole 22 and the inside diameter 12 are nominally the same diameter. The level of the underflow weir hole 20 is substantially higher than that of the liquid level. Liquid born materials heavier than the liquid will fall to the inside surface 41 of the weir whereas materials lighter than the liquid will rise to the liquid surface but will be prevented from flowing out of the weir as they lodge against the underflow weir 8. Both lighter and heavier material will be trapped within the centrifugal weir assembly.

The liquid flows out of the weir assembly at 14 through the discharge hub 13. A discharge bell 15 envelops the discharge hub 13 and provides a discharge path for the liquid flow. A boost pump 23 provides sufficient suction to match the flow rate of the weir assembly. The weir body 1 is rotating at elevated angular velocity while the discharge bell 15 remains stationary. Consequently, a discharge bell air gap 40 is provided which allows free rotation. The boost pump 23 is adjusted to allow a small amount of leakage past the air gap 40 during normal operation. In another configuration, the boost pump 40 may be adjusted to allow a small excess suction so that air will be drawn through the air gap 40. With the latter configuration, the boost pump 23 must be designed to tolerate cavitation without damage to the pump.

Direction of liquid flow within the weir body 1 is determined without any moving parts or external pump devices. By constructing the drive hub 11 inside diameter 10 at a higher level than the inside diameter 12 of the discharge hub 13, the liquid must flow to the lowest point. The liquid is accelerated through its flow path in the weir body 1 by the high gravitational forces exerted on it.

Inasmuch as the weir body 1 is rotating at elevated angular velocity and the infeed pipe 4 and the discharge bell 15 are stationary, a bushing made of an anti-friction material is provided which prevents galling of metal-to-metal surfaces. An infeed pipe bushing 16 is mounted with an interference fit on the infeed pipe 4 and a discharge bell bushing 17 is mounted with an interference fit into the inside of the discharge bell 15. In neither case is the bushing intended to act as a bearing surface. It is provided merely as an anti-galling device in the case of inadvertent contact between the rotating weir body and the stationary members.

FIG. 3 shows the weir assembly as it would appear in operation. A catch basin 24 is provided to collect the liquid leakage. In practice, this liquid can be returned to the weir assembly for repeated processing by means of a return pump. A directional flow valve 26 prevents the flow of liquid from the pressurized infeed pipe through the return pump 25 to the catch basin 24.

The centrifugal weir may operate continuously until there is sufficient accumulation of foreign material to prevent efficient operation. Cleaning intervals will be determined entirely by the degree of contamination of the liquid in the system and the requirements of each unique installation.

FIG. 5 shows the weir body in the wash-down position. Prior to tipping, both the infeed pipe 4 and the discharge bell 15 are retracted as shown by arrows 67 and 68 on FIG. 4. The weir body 1 is then elevated as shown in FIG. 5. The weir body 1 is rotated at a slow angular velocity while a pressure-washing wand 27 is lowered into the weir body 1. The washing wand 27 progressively passes through the underflow weir hole 20 of each successive underflow weir 8. The washing wand 27 is equipped with a plurality of spray nozzles 28 and 29. In order to balance the thrust forces on the washing wand 27, the spray nozzles 28 and 29 are always mounted in opposing pairs of either two or four. In addition, the spray nozzles 28 and 29 have independent spray orientations 30 and 31 in order to more thoroughly wash the entirety of the centrifugal weir. This spray nozzle orientation is particularly useful in clearing debris from the space 19 between the weir body 1 and the underflow weir 8.

It is advantageous to maintain a high concentration of the contaminated wash liquid. This is done by means of re-circulation of the washing liquid. In the wash-down mode, a wash-down catch basin 39 is used to collect all effluents. Depending on the particular process, the wash-down catch basin may be used as a settling basin. A wash-down catch basin pump 32 then circulates the wash liquid to additional clarification stations. In one embodiment, this may include a hydro-cyclone with a secondary solids catch basin 34. The cleaner liquid is then discharged into a clear-water settling tank 35 where it is drawn through a final filter 36 and back into the pressure wash pumps 37. Other embodiments may use diverse filtration methods depending on the contaminated liquid of the process.

Because the pressure-washing wand 27 is extendable, flexible lines 38 are provided to facilitate a full range of movement.

FIG. 6 shows another embodiment that is compact and uses a disposable or replaceable cartridge. This configuration is intended for use in dental offices to separate mercury-laden amalgam from water and the like. The weir cartridge 43 is generally made of thin gage metals and would distort or rupture at normal operational forces. Therefore, a drive housing 42 is used to confine the cartridge element and provide the mechanical framework for the bearings 44, externally mounted sheave 61 and idler wheels 45. The weir cartridge 43 is designed so that it will safely contain contaminated solids. This is accomplished with the combination of an infeed valve 49 and discharge valve 55 which are closed when the unit is at rest or when the cartridge 43 is removed from the unit. The infeed pipe 54 is movable as indicated by arrow 62. When the infeed pipe 54 is retracted, the infeed valve spring 51 expands and presses the infeed valve seal 52 against the weir cartridge 43 at 63, thus sealing the infeed end of the cartridge. Similarly, when the tension is relaxed on the infeed valve 49, the discharge valve spring 57 will extend and the discharge valve seal 58 will rest against the discharge end of the cartridge at 64 and seal the discharge end of the weir cartridge 43. The discharge valve push rod 59 is also retractable as indicated by arrow 65, which further allows the discharge valve 55 to close.

The weir cartridge 43 provides identical liquid movement as required in the industrial weir body 1. The weir cartridge 43 forces the liquid to follow a tortuous path 70 through space 71 and over the subsequent overflow baffle 47.

Typical water evacuator pumps in dental offices are vacuum driven systems that draw both water and air. With that type of evacuator connected to the discharge bell 60, leakage of water to the outside of the cartridge is eliminated. Wiper material is attached to the discharge bell 60 at 66. Potential leakage is eliminated as air is drawn into the system at this point. Similarly, an infeed wiper 69 is attached to the weir cartridge 43 surrounding the infeed pipe 54. The evacuator pump will draw moisture with included air into the cartridge thus preventing leakage around the infeed pipe 54. When the weir cartridge 43 is idle and the two weir cartridge valves 49 and 55 are closed, partial vacuum from the evacuation pump will not cause leakage of contaminated liquid within the cartridge as the discharge valve 55 is further sealed by the presence of the vacuum.

When loading or unloading the weir cartridge 43 from the drive housing 42, the discharge valve push rod 59 and the infeed pipe 54 are simultaneously retracted. In addition, provision is also made so that the infeed pipe 54 can be shifted to allow adequate clearance for manipulation of the weir cartridge 43.

This invention does not address control of the motor drive of the embodiment employing a cartridge. However, the drive and other controls would be programmed so that the infeed valve 49 and discharge valve 55 would automatically close prior to any shutdown of the drive. This would prevent the loss of contaminated water from the cartridge. At initial start up, rotational speed of the drive housing 42 would accelerate to a point at which the solids would be held in place in the cartridge before the valves would be opened. Additional controls could be incorporated to synchronize valve operation and motor speed with water flow and cartridge restriction.

What I claim is:

1. A centrifugal weir to separate solid and liquid components of a waste water stream, comprising:
a) an elongate cylindrical weir body being rotatable about a horizontal axis;
b) an infeed means at one extremity and a discharge means at the other extremity of said elongate cylindrical weir body;
c) at least one fixed annular overflow baffle internally affixed to said cylindrical weir body having a liquid overflow level approximately equal to that of the liquid discharge level;
d) at least one internally fixed annular underflow weir plate defining an annular space between said cylindrical weir body and said fixed annular underflow weir plate having a liquid overflow level substantially above that of said liquid discharge level;
e) at least one fixed baffle plate substantially perpendicular to said fixed annular underflow weir plate;
f) a high liquid level barrier at an infeed portion of said cylindrical weir body in cooperation with a low liquid level barrier at the discharge portion of said cylindrical weir body that determines the direction of liquid flow within said elongate centrifugal weir body.

2. A centrifugal weir according to claim 1, wherein the liquid infeed pipe is unattached and retractable from said rotating centrifugal weir body.

3. A centrifugal weir according to claim 1, wherein the liquid discharge bell is unattached and retractable from said rotating centrifugal weir body.

4. A centrifugal weir according to claim 1, wherein said centrifugal weir body may be tipped from a horizontal orientation to a vertical orientation for cleaning.

5. A centrifugal weir according to claim 1, wherein a pressure washing wand is extendable into said vertically oriented weir body for the purpose of cleaning the internal walls of said centrifugal weir.

6. A centrifugal weir according to claim 1, wherein said centrifugal weir body is a removable cartridge.

7. A centrifugal weir according to claim 6, wherein said removable cartridge has an internal inlet valve for the purpose of sealing the infeed portion of said removable cartridge.

8. A centrifugal weir according to claim 6, wherein said removable cartridge has an internal discharge valve for the purpose of sealing the discharge portion of said removable cartridge.
